(19) United States
(12) Patent Application Publication
(10) Pub. No.: US 2006/0170318 A1
(43) Pub. Date: Aug. 3, 2006

(54) Discharge lamp

(75) Inventors: Shunichi Morimoto, Himeji-shi (JP); Norihiro Inaoka, Himeji-shi (JP); Kyosuke Fujina, Himeji-shi (JP)

Correspondence Address: ROBERTS, MLOTKOWSKI & HOBBES, P. O. BOX 10064, MCLEAN, VA, 22102-8064, US

(73) Assignee: Ushiodenki Kabushiki Kaisha, Tokyo (JP)

(21) Appl. No.: 11/340,456

(22) Filed: Jan. 27, 2006

(30) Foreign Application Priority Data
Jan. 31, 2005 (JP) 2005-022972

(51) Int. Cl. H01J 7/24

(52) U.S. Cl. 313/46

(57) ABSTRACT

A discharge lamp of the short arc type in which the temperature rise of the sealing components of graded glass within the sealing part can be suppressed and in which the sealing components are not damaged is achieved, in a such lamp that has sealing parts which border the arc tube on opposite sides, and lead pins which each support a electrode in the arc tube, and are sealed within the respective sealing part by graded glass, by a component for cooling the sealing part being provided on the outside of at least one of the sealing parts, and by a component for cooling the lead pin being provided on at least one of the lead pins, in the area in which it projects outward from the graded glass within the sealing part which is provided with the component for cooling the sealing part.

### BACKGROUND OF THE INVENTION

1. Field of the Invention

The invention relates to a discharge lamp of the short arc type. The invention relates, for example, to a discharge lamp of the short arc type which is suited for a light source of a projector device or the like, in which light modulation elements are irradiated with light and in which images are projected by the reflected light.

2. Description of the Related Art

A conventional discharge lamp of the short arc type with an arc tube 11 filled with xenon is shown in FIG. 7 and is known for use as a light source of a projection device, such as a projector or the like. In this lamp, as a result of increasing the radiance, the internal pressure of the arc tube 11 is very high during operation, so that a construction is required such that, even at a high internal pressure, the sealing parts 12 of the lamp are not damaged. Furthermore, it is necessary for the lead pins 23 which support electrodes 21, 22 to project to the outside from the sealing parts 12 which border the arc tube 11 since a large current is allowed to flow in the lamp. For hermetic sealing of the sealing parts 12 to the lead pins 23, therefore, graded glass 13 is used (see, JP 2001-216938 A and JP 2003-059454 A).

However, recently, there has been the trend toward a projection device, in which this discharge lamp of the short arc type has been installed, being transported and used at various locations. Therefore, there is a need for a compact, small projection device and a reduction in the size of the lamp. To make the lamp smaller, the length of the lamp must be reduced. Relating to the discharge lamp of the short arc type shown in FIG. 7, it is necessary to shorten the distance L between the back end of the anode 21 and a sealing component 131 in which the lead pin 23 is sealed by means of the graded glass 13. However, shortening of this distance L leads to the sealing component 131 of graded glass 13 approaching the anode 21. Since the temperature of the anode 21 is high, the temperature of the sealing component 131 increases, by which the disadvantage of damage to the sealing component 131 occurs.

Furthermore, within the arc tube 11, the anode 21 and the cathode 22 are located opposite each other. The lead pins 23 which support the anode 21 and the cathode 22 are each inserted into a cylindrical retaining body 24. The area of the sealing part 12 in which the respective cylindrical retaining body 24 is located is heated and reduces its diameter, by which a pinched area 121 is formed and the electrodes 21, 22 are supported.

In this pinched area 121, the area between the inside of an opening of the cylindrical retaining body 24 into which the lead pin 23 is inserted, and the outside of the lead pin 23 is not completely welded on, but the interior of the arc tube 11 and the interior of the sealing part 12 are continuously connected to one another. This results in the following disadvantage:

The added gas in the high temperature state in the interior of the arc tube 11 flows into the sealing part 12 and collides with the sealing components 131 of the respective graded glass 13, damaging the sealing components 131.

### SUMMARY OF THE INVENTION

The invention was devised to eliminate the aforementioned disadvantages. Thus, a primary object of the present invention is to devise a discharge lamp of the short arc type in which the temperature rise of the sealing components can be suppressed and in which the sealing components are not damaged even if, by making the lamp smaller, the distance is shortened between the back end of the electrode within the arc tube and the respective sealing component in which graded glass is sealed within the sealing part on the lead pin, and even if the added gas in the interior of the arc tube flows into the interior of the sealing part.

The object is achieved according to a first aspect of the invention in a discharge lamp of the short arc type in which a sealing part which borders the arc tube, and lead pins which support the electrodes, are sealed within the sealing part by graded glass, in that there is a component for cooling the sealing part on the outside of the sealing part, and that there is a component on the lead pin for cooling the lead pin on which the component for cooling the sealing part is located.

The object is achieved in a development of the invention in the described discharge lamp of the short arc type in that, especially the above described graded glass, has a sealing component which is sealed on the lead pin, and a rising part which borders this sealing component and rises such that its distance from the lead pin increases, and that the component for cooling the sealing part is located at least starting from the rising part of the above described graded glass toward the side of the arc tube.

The object is achieved according to another development of the invention in that especially the above described component for cooling the sealing part and the component for cooling the lead pin form a one-piece, plate-like heat radiation plate.

The discharge lamp in accordance with the invention yields the following advantages:

A smaller lamp is obtained. Even if the distance between the back end of the electrode in the arc tube and the sealing component in which the graded glass is sealed within the sealing part on the lead pin becomes shorter, the added gas which flows into the sealing part can be reliably cooled by means of the component for cooling the sealing part, which component is located in the sealing part.

Thus, the lead pin is reliably cooled by the component for cooling the lead pin which is connected to the lead pin. Therefore, a temperature increase of the sealing component of the graded glass which is connected to the lead pin located inside the sealing part, and a temperature increase of the rising part can be suppressed.

Accordingly, a small discharge lamp of the short arc type with a long service life in which damage to the graded glass can be prevented is obtained.

The invention is described in greater detail below with reference to the accompanying drawings.

### BRIEF DESCRIPTION OF THE DRAWINGS

FIG. 1 is a schematic sectional view of a discharge lamp of the short arc type in accordance with an embodiment of the invention;

FIG. 2 is a cross-sectional view taken along line A-A in FIG. 1;

FIG. 3 is a cross-sectional view taken along line B-B in FIG. 1;

FIG. 4 is an enlarged schematic cross-sectional view showing the positional relationship between the component for cooling the sealing part, which component is located on the sealing part, and the graded glass,

FIG. 5 is a view corresponding to that of FIG. 1, but showing another embodiment of the component for cooling the sealing part and the component for cooling the lead pin;

FIG. 6(a) is a cross-sectional view taken along line A-A in FIG. 5;

FIG. 6(b) is a cross-sectional view taken along line B-B in FIG. 5; and

FIG. 7 is a schematic cross-sectional view of a conventional discharge lamp of the short arc type.

### DETAILED DESCRIPTION OF THE PREFERRED EMBODIMENTS

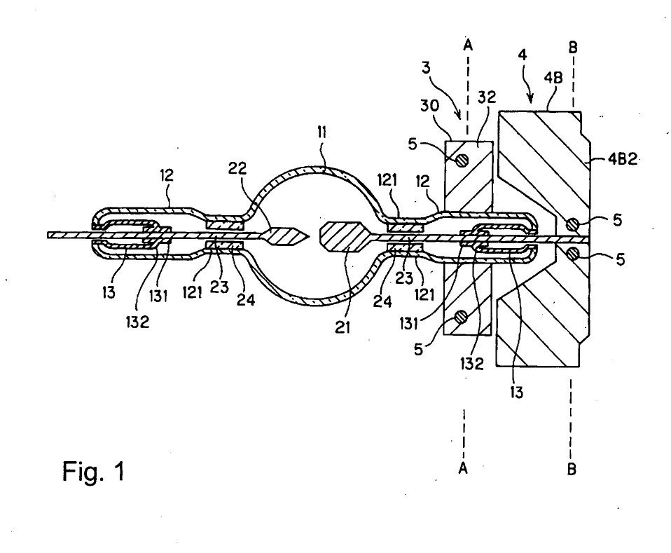

A discharge lamp of the short arc type in accordance with the invention is described below using FIG. 1. An essentially spherical arc tube 11 of silica glass is integrally and continuously connected on each of opposite sides to a respective sealing part 12. The arc tube 11 is filled with xenon gas, and a pair of electrodes, i.e., an anode 21 and a cathode 22, are located in opposed relationship to each other. The anode 21 and cathode 22 are each joined to the tip of a tungsten lead pin 23.

Silica glass cylindrical retaining bodies 24are located within the sealing parts 12 at their ends that are near the respective side of the arc tube 11. Lead pins 23, which support either the anode 21 or the cathode 22, are inserted into an opening which has been formed in the middle of the respective cylindrical retaining body 24. Pinched parts 121 are formed, and thus, the electrodes are supported by heating and by reducing the diameter of the sealing parts 12 in which the cylindrical retaining bodies 24 are located.

Within the sealing parts 12, there is a graded glass part 13, one end of which is made of glass with a coefficient of expansion which agrees with that of the silica glass comprising the sealing parts 12 and is welded to the end of the sealing parts 12, and the other end of which is made of a glass with a coefficient of expansion which agrees with that of the tungsten comprising the lead pins 23 and is sealed on the lead pin 23 by a respective sealing component 131. The sealing component 131 of the graded glass 13 has a rising part 132 which borders the sealing component 131 and rises such that its distance from the lead pin 23 increases. The lead pins 23 project, proceeding from the sealing component 131 of the graded glass 13, from the sealing parts 12. A supply device, which is described below, is connected to these projecting parts.

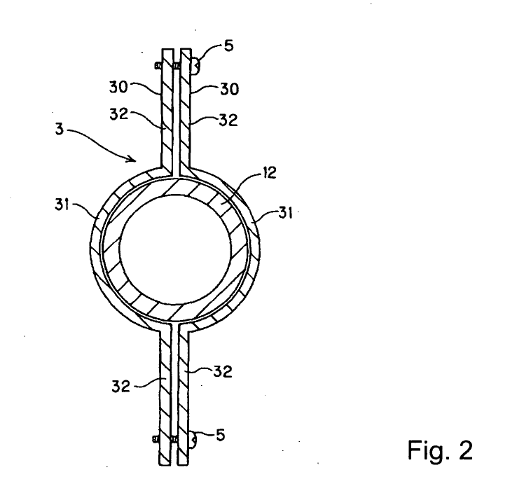

FIG. 2 is a cross-sectional view taken along line A-A in FIG. 1 and shows only the sealing part and the component for cooling the sealing part described below. As shown in FIGS. 1 & 2, on the outside of the sealing part 12, there is a component 3 for cooling the sealing part which is formed of a pair of aluminum plates 30.

The component 3 for cooling the sealing part has securing regions 31 which are formed in such a way that they directly tightly adjoin the outside of the sealing part 12, and heat radiation parts 32 extend outward the securing regions 31 and from the optical axis of the discharge lamp. The aluminum plates 30 are attached to one another in the heat radiation part 32 by means of screws 5 and are fixed in the respective securing region 31, such that they clamp the sealing part 12. As a result, there is the component 3 on the sealing part 12 for cooling the sealing part in the state in which it is in contact with the outer periphery thereof. Thus, the temperature of the sealing part 12 is actively reduced.

The region between the inside of the opening of the respective cylindrical retaining body 24 which is located in the sealing part and into which the lead pin 23 is inserted, and the outside of the respective lead pin 23 is not completely welded on, but the interior of the arc tube 11 and the interior of the sealing part 12 are continuously connected to one another. The added gas which is in a high temperature state in the interior of the arc tube 11 therefore flows into the sealing parts 12.

However, since the sealing parts 12 are actively cooled by the component 3 for cooling the sealing part, the temperature gradient between the added gas flowing into the sealing parts 12, and the sealing parts 12 becomes large. The heat of the added gas flowing into the sealing parts 12 is therefore reliably routed away from the sealing parts 12, by which the temperature of the added gas flowing into the sealing parts 12 can be reduced.

On the other hand, the added gas flowing into the sealing parts 12 collides with the sealing components 131 and the rising parts 132 of the graded glass 13. However, since the temperature of this colliding added gas has dropped, the sealing components 131 and the rising parts 132 are prevented from being heated and thermal warping in the sealing components 131 and the rising parts 132 is prevented. Thus, the sealing components 131 and the rising parts 132 can be prevented from being destroyed.

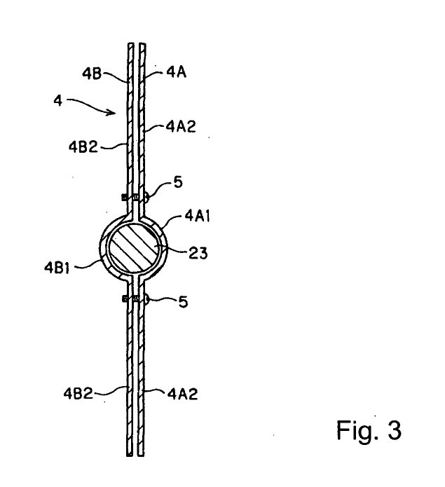

FIG. 3 shows a cross section taken along line B-B in FIG. 1. As shown in FIGS. 1 & 3, the lead pin 23 is connected to the component 4 for cooling the lead pin with a part formed of an aluminum plate 4A and another part made of a copper plate 4B with a surface which has been galvanized with nickel.

This component 4 for cooling the lead pin is formed as follows:

In a part of the aluminum plate 4A and in a part of the copper plate 4B, securing parts 4A1, 4B1 are formed such that they are located directly tightly adjoining along the outer periphery of the lead pin 23. Heat radiation parts 4A2, 4B2 extend to the outside bordering these middle adhesive parts 4A1 and 4B1 such that their distance from the optical axis of the discharge lamp increases. The aluminum plate 4A and the copper plate 4B are attached to one another in the heat radiation parts 4A2, 4B2 by means of screws 5 and are fixed in the securing parts 4A1, 4B1 such that they clamp the lead pin 23.

As a result, the aluminum plate 4A and the copper plate 4B are connected to the lead pin 23 with high thermal conductivity. Therefore, the heat of the lead pin 23 can be actively radiated by means of the component 4 for cooling the lead pin, and thus, the temperature increase of the sealing component 131 can be suppressed.

The reason why the copper plate 4B forms a part of the component 4 for cooling the lead pin is to improve the electrically conductive property. The copper plate 4B is connected to a line (not shown) and which is connected, in turn, to the current source. This copper plate 4B also acts as a supply device for delivering current to the lamp.

Next, a discharge lamp of the short arc type with the specification described below was produced and tests were run by which the temperature of the sealing components of the graded glass was studied at a time 900 hours after the start of operation.

(Basic Arrangement of the Lamp)

Total lamp length: 235 mm

Silica glass sealing part, outside diameter 24 mm, thickness 2.5 mm

Linear distance between the sealing component of graded glass and the anode: 59.5 mm

Tungsten lead pin diameter: 4.0 mm

Distance between electrodes: 4.0 mm

Lamp wattage: 2 kW

(Component for Cooling the Sealing Part)

Form: two metallic plates

Material: aluminum

Total area of the two metallic plates (including the adhesive surface with the sealing part): 10600 mm²

Securing area of the two metallic plates with the sealing part: 2030 mm²

(Component for Cooling the Lead Pin)

Form: two metallic plates

Material: one of the metallic plates is made of aluminum.

Material: the other metallic plate is made of copper with a surface which is galvanized with nickel.

Total area of the two metallic plates (including the region secured with the sealing part): 9700 mm²

Adhesive area of the two metallic plates with the sealing part: 132 mm²

The test result is shown using Table 1.

TABLE 1

| | Presence or ab- | Presence or | |
|---|---|---|---|
| | sence of the | absence of the | Temperature (° C.) |
| | component for | component for | of the sealing |
| | cooling the | cooling the | components of |
| | sealing part | lead pin | the graded glass |
| Lamp 1 | Absent | Absent | 540 |
| (comparison | | | |
| example) | | | |
| Lamp 2 | Present | Absent | 520 |
| (comparison | | | |
| example) | | | |
| Lamp 3 | Present | Present | 480 |
| (embodiment) | | | |

As becomes apparent from the above described test, the temperature of the sealing components of the graded glass in the lamp 3 of the invention which has the component for cooling the sealing part and the component for cooling the lead pin, compared to the lamp 1 without the component for cooling the sealing part and without the component for cooling the lead pin, is 60° C. lower.

In the lamp 2 which has only the component for cooling the sealing part, the temperature of the sealing components of the graded glass can be lowered by 20° C. compared to the lamp 1 which has neither a component for cooling the sealing part nor a component for cooling the lead pin. The cooling effect to such a degree is, however, not sufficient, but in the sealing components thermal warping arises by which the sealing components are damaged in operation over a long time.

Therefore, in the lamp 3 in accordance with the invention, the added gas which has flowed from the arc tube into the sealing part is reliably cooled by means of the component for cooling the sealing part. Furthermore, the lead pin is cooled directly by means of the component for cooling the lead pin. By a synergistic effect of the two with one another, therefore, the sealing components of graded glass and the rising parts can be reliably cooled with high efficiency. Thus, thermal warping can be prevented in the sealing components and in the rising parts even when the lamp is operated over a long time, and the sealing components can be prevented from being damaged.

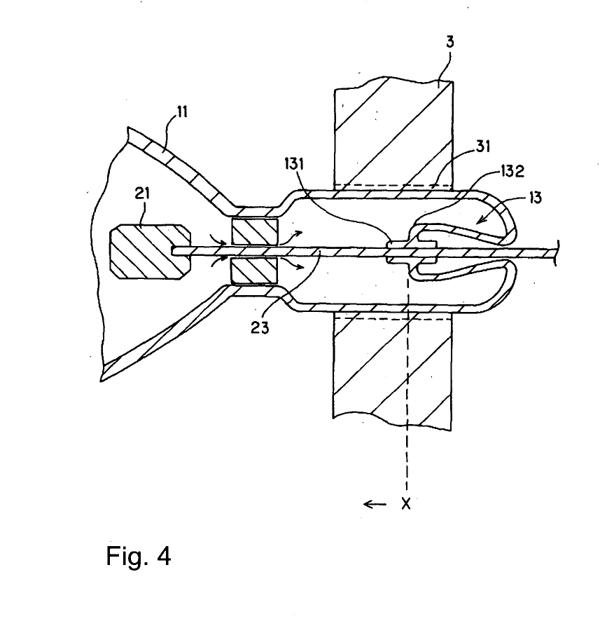

FIG. 4 is a schematic of the positional relationship between the component for cooling the sealing part which is located in the sealing part, and the graded glass. As shown in FIG. 4, there are securing parts 31 (advantageously represented by the regions which are shown by the broken line) of the component 3 for cooling the sealing part from the rising parts 132 of the graded glass 13 toward side of the arc tube 11. Specifically, one part of the component 3 for cooling the sealing part starting from position X at which the respective rising part 132 is located is present in the direction of the arrow, i.e. on the side of the arc tube 11.

The rising part 132 is a region which, proceeding from the sealing component 131, rises in the direction in which the distance from the lead pin 23 increases. This region is subjected to bending treatment in the direction to the end of the sealing part 12, and warping from treatment remains in this region. There is the danger here that it will be easily destroyed if in the state in which the treatment warping is present it is heated to a high temperature by the added gas which has flowed into the sealing part 12.

Because part of the component 3 for cooling the sealing part, starting from position X at which the respective rising part 132 is located, is also present in the direction of the arrow on the side of the arc tube 1, the added gas with a high temperature which flows through the gap between the cylindrical retaining body 24 and the lead pin 23 upstream of the rising part 132, however, can be reliably cooled and a temperature increase of the rising part can be more reliably suppressed.

In the above described embodiment, using the description from FIG. 1, in a part of the sealing part 12 (on the right in the figure), there is the component 3 for cooling the sealing part, and in the lead pin which projects from this part of the sealing part 12, there is the component 4 for cooling the lead pin.

The other part of the sealing part 12 (on the left in the figure) extends from an opening formed in the uppermost part of the reflector to the back of the reflector and is held by a lamp retaining body on the back of the reflector. In this arrangement, the light is not emitted directly from the reflector, and a part of the sealing part 12 (on the right in the figure) is located in the reflector, the light reflected by the reflector being emitted onto the sealing part (on the right in the figure). Thus, the graded glass 13 and the lead pin 23 within the sealing part 12 are heated. The component 3 for cooling the sealing part and the component 4 for cooling the lead pin are therefore located only on the side of a part of the sealing part 12 (on the right in the figure).

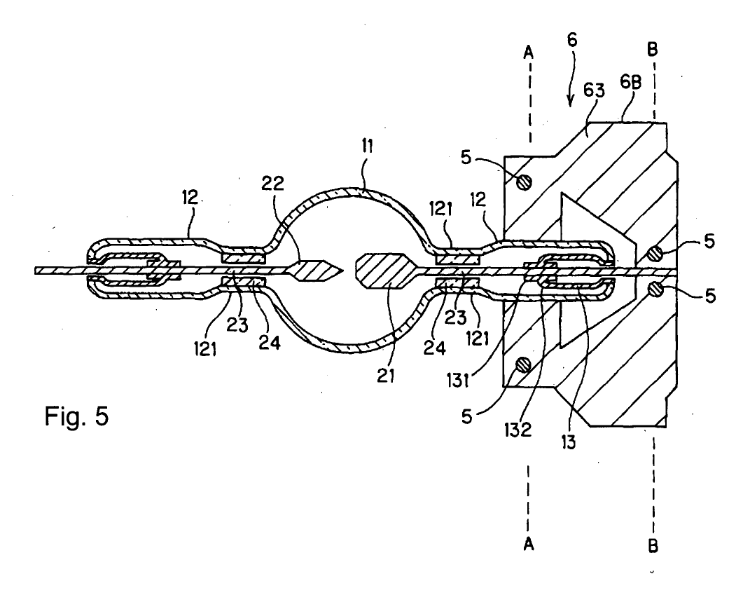

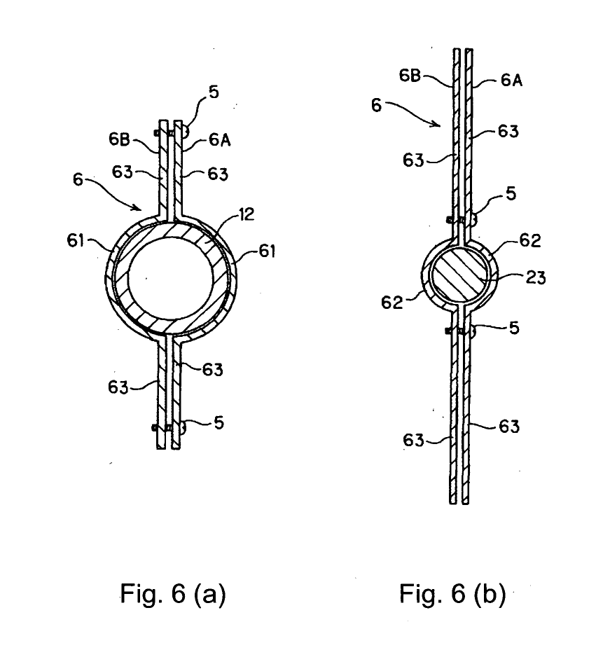

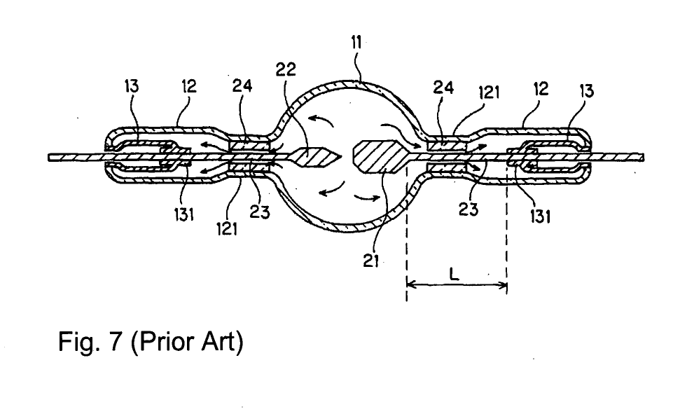

FIG. 5 shows another embodiment of the component for cooling the sealing part and the component for cooling the lead pin, the two components being formed integrally with one another. FIG. 6(a) is a cross section taken along line A-A in FIG. 5. Here, only the sealing part and the cooling component are shown. FIG. 6(b) is a cross section taken along line B-B in FIG. 5. As shown in FIGS. 5, 6(a) & 6(b), the cooling component 6 is formed of two metallic plates, of which a metallic plate 6A is an aluminum plate and the other metallic plate 6B is a copper plate with a surface that has been galvanized with nickel. The respective metallic plate has a securing part 61 which is located directly tightly adjoining the outside of the sealing part 12, a lead pin securing part 62 which is located directly tightly adjoining the outside of the lead pin 23, and a heat radiation part 63 which extends outward from the securing parts 61, 62 such that its distance from the optical axis of the discharge lamp increases. The respective metal plate is inseparably attached in the heat radiation part 63 by means of a screw and is fixed in the securing parts 61, 62 such that the sealing part 12 and the lead pin 23 are clamped.

Using such a cooling component 6 simplifies the effort for installing the cooling component 6 in the lamp, and moreover, the number of parts can be reduced.

What is claimed is:

1. Discharge lamp of the short arc type, comprising:
an arc tube,
sealing parts which border the arc tube on opposite sides,
a pair of opposed electrodes in the arc tube,
lead pins, each of which support a respective one of the electrodes and each of which is sealed within a respective sealing part by graded glass,
a component for cooling the sealing part on the outside of at least one of the sealing parts, and
a component for cooling the lead pin on the at least one of the lead pins provided with the component for cooling the sealing part, the component for cooling the lead pin being provided in an area in which the lead pin projects outward from the graded glass within the sealing part.

2. Discharge lamp of the short art type as claimed in claim 1, wherein the graded glass has a sealing component which is tightly connected to the lead pin, and a rising part which is connected to the sealing component and which rises such that its distance from the lead pin increases in a direction away from the sealing component, and wherein the component for cooling the sealing part is located in an area extending at least from a location corresponding to that of the rising part of the graded glass in a direction toward a respective side of the arc tube.

3. Discharge lamp of the short art type as claimed in claim 1, wherein the component for cooling the sealing part has an annular part which closely adjoins the sealing part, essentially completely surrounding it, and has two blade components extending radially outward from the annular part.

4. Discharge lamp of the short art type as claimed in claim 3, wherein the component for cooling the sealing part comprises two mirror-symmetrical halves, a plane of mirror symmetry running through a plane of the blade components.

5. Discharge lamp of the short art type as claimed in claim 1, wherein the component for cooling the lead pin has an annular part which closely adjoining the lead pin, essentially completely surrounding it, and two blade components extending radially outward from the annular part.

6. Discharge lamp of the short art type as claimed in claim 5, wherein the component for cooling the lead pin comprises two mirror-symmetrical halves, a plane of mirror symmetry running through a plane of the blade components.

7. Discharge lamp of the short art type as claimed in claim 1, wherein the component for cooling the sealing part and the component for cooling the lead pin form a unit with a common plate-shaped heat radiation plate.

8. Discharge lamp of the short art type as claimed in claim 4, wherein the component for cooling the lead pin has an annular part which closely adjoining the lead pin, essentially completely surrounding it, and two blade components extending radially outward from the annular part, and wherein at least one of the component for cooling the sealing part and the component for cooling the lead pin has one half formed of an aluminum plate and another half formed of a copper plate with a surface which has been galvanized with nickel.

9. Discharge lamp of the short art type as claimed in claim 1, wherein the outer lead pin which is provided with the component for cooling the lead pin is the outer lead pin for the anode.

10. Discharge lamp of the short art type as claimed in claim 2, wherein the component for cooling the sealing part has an annular part which closely adjoins the sealing part, essentially completely surrounding it, and has two blade components extending radially outward from the annular part.

11. Discharge lamp of the short art type as claimed in claim 10, wherein the component for cooling the sealing part comprises two mirror-symmetrical halves, a plane of mirror symmetry running through a plane of the blade components.
